(19) United States
(12) Patent Application Publication
(10) Pub. No.: US 2013/0228446 A1
(43) Pub. Date: Sep. 5, 2013

(54) Device and Process for Removing Contaminants from a Fluid Using Electromagnetic Energy

(71) Applicant: Scott Shumway, Hinesburg, VT (US)

(72) Inventor: Scott Shumway, Hinesburg, VT (US)

(21) Appl. No.: 13/411,569

(22) Filed: Mar. 4, 2012

(51) Int. Cl. B01D 3/06; H05B 6/64

(52) U.S. Cl. 202/153; 219/678

(57) ABSTRACT

A device and process for removing contaminates from a process fluid employing microwave energy has been described. The use of a quartz tube, which allows for the efficient transfer of microwave energy to a contaminated process fluid is employed to raise the temperature of the process fluid and a flash vaporization technique allows for the removal of uncontaminated fluid. This process decreases the amount of scaling that may collect on the surfaces of the device which increases the devices efficiency and useful life.

### BACKGROUND OF THE INVENTION

This invention relates generally to fluid treatment systems, and more particularly to a device and process which employs the use of electromagnetic energy, i.e. microwave energy, to superheat a contaminated fluid and remove contaminants from the fluid.

### SUMMARY OF THE INVENTION

As a consequence of some natural and industrial process applications, solutions containing high levels of total dissolved solids are generated. One example would be the presence of highly saline solutions known as “produced water” which is a byproduct of hydrocarbon extraction. Disposal of the produced water is a problem where for various environmental reasons reinjection of the fluid is not advisable or even allowed. Because of the high salinity, the solutions are toxic to aquatic creatures and are therefore not suitable for surface disposal. Currently there are two techniques for removal of this fluid. One method concerns the collection and transport in tanker trucks to a site where it is legal for reinjection into the ground.

Another method concerns the collection and transport in tanker trucks to a centralized processing facility. These facilities remove the water from the contaminated solution to a degree where the volume of water is greatly reduced. The output from these systems is either a wet paste that can be disposed of in a landfill, or a dry crystalline product that is suitable for industrial uses and winter road dispersion. The industrial plants that can process fluids of this nature are often called Zero Liquid Discharge (ZLD) processing plants, and require a large investment.

In many areas of the country, the availability of legal injection boreholes is limited and requires long hauling distances of large volumes of fluid and is therefore not cost effective and impractical. ZLD processing plants are generally regional and the operation of these plants is very costly and complex. As the demand for natural gas and hydrocarbons has increased, the demand for processes that can offer an alternative to traditional ZLD processing plants are highly desirable.

A standard ZLD plant is a thermal system that very basically seeks to remove water by using heat to create water vapor, leaving behind the mineral and salt constituents. These plants consist of various combinations of boilers, multi-effect desalinators and brine crystallizers as well as pretreatment systems, post treatment systems and handling equipment. The operation of these systems requires precise control and skilled operations staff. The permitting, design, and construction of these systems requires significant investment and the timeline from concept to production is long.

A major problem with very high salinity fluids containing various minerals and salts is the tendency of these minerals and salts to form scale on the heating surfaces. The burning of fuel to create heat, and in turn, to heat up highly saline water requires that a heat exchanger be available. Generally, the heat exchanger is more efficient if it operates at high temperature. However, high temperature heat exchangers where boiling occurs at the heat exchanger surface are highly susceptible to the formation of scale. If scaling of this surface occurs, then the ability of the heat exchanger to transfer heat to the fluid is retarded. Over time with increasing build up, the heat exchanger will cease to function. Even small amounts of scale will reduce the efficiency of the process.

Scale is the precipitation and deposition of mineral and salt constituents on a surface. The more saline and hard the water, the higher the tendency that scale will form, especially on the heat exchanger surfaces. It is possible to reduce the temperature of the heat exchanger, however to transfer the same amount of energy, the heat exchanger must become much larger resulting in greater cost. A device that can add heat energy to a highly saline solution with saturated or even super saturated mineral content while at the same time not having the tendency for scale to form on the interface would be highly desirable.

Adding heat energy to a fluid is not limited to the use of conduction and convection using a heat exchanger (boiler). Another option in this case, would be to use microwave energy. The benefit of using microwave energy for this purpose is that it heats up the bulk fluid from within, and there are no hot surfaces that will be pre-disposed to the build-up of scale as found with a traditional heat exchanger.

Some of the benefits of the invention include:

1. The use of electrical energy to supply the heat eliminates the need for fuel handling, boilers, emissions, ash, and other problems associated with combustion.

2. Use of electrical energy to heat the fluid reduces environmental and regulatory permitting time.

3. The use of electrical energy instead of combustion greatly reduces the size of the equipment, thereby allowing it to be portable.

4. Scaling formation is greatly reduced in the apparatus where energy is added to the solution for the purposes of raising the temperature to a point where the solution is able to boil or beyond as the design might dictate, however the energy added does not include a heat exchanger surface and is instead added by subjecting the bulk fluid to microwave radiation.

5. System is easily scalable, whereby additional capacity can be added such that additional flow can be accommodated as it is required.

In accordance with these and other objects which will become apparent hereinafter, the instant invention will now be described with reference to the accompanying drawings

### BRIEF DESCRIPTION OF THE DRAWINGS

FIG. 1 is a simplified schematic view of an embodiment of the invention where microwave energy is used to create a superheated process fluid;

FIG. 2 is a simplified schematic view of an embodiment of the invention where microwave energy is used to separate contaminants from a process fluid

### DETAILED DESCRIPTION

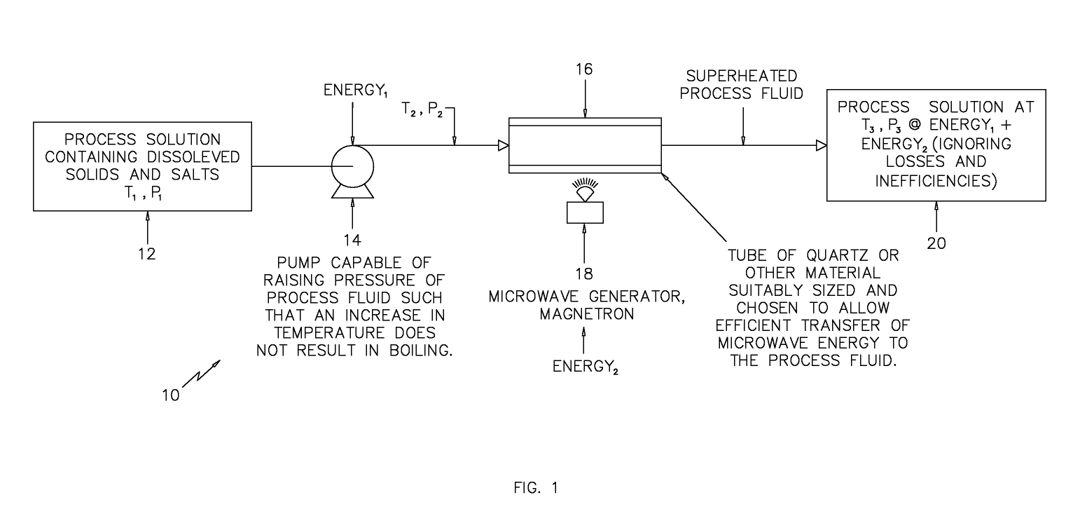

Referring first to FIG. 1, which depicts a simplified schematic of a process and device 10 for raising the temperature and pressure of a process fluid in accordance with the invention. It is well known that some materials are reflective to microwave energy such as metals and many other materials. In the same way, there are materials such as quartz glass that are very efficient at allowing microwave radiation to pass through.

A process fluid 12 which may contain contaminants such as dissolved solids and salts is provided to a pump 14 at a given temperature (T1) and pressure (P1). The fluid pump 14, which may be of any well known type, raises the pressure of the process fluid 12 to (P2). Temperatures T1 and T2 are substantially equal. The process fluid is then transferred to a suitably sized and configured quartz tube 16 and a magnetron (electromagnetic energy source) 18 is configured to transmit microwave energy to the process fluid 12 as it flows through the quartz tube 16. When the process fluid 12 leaves the quartz tube 16, it is at superheated state at temperature T3 and pressure P3. Pressures P2 and P3 may be substantially equal.

The quartz tube 16 is appropriately sized and configured to allow for efficient transfer of microwave energy to the process fluid. It should be mentioned that the quartz tube 16 could be constructed of any material that allows for the transfer of microwave energy into the bulk process fluid 12, but does not itself increase in temperature due to the microwave energy. This characteristic will help prevent the build-up of scale along the inside wall of the quartz tube 16.

It should also be mentioned that while the description of the invention has focused on microwave energy, which may fall into a specific range of wavelengths of the electromagnetic spectrum, the invention contemplates the transfer of energy by means of any electromagnetic wave.

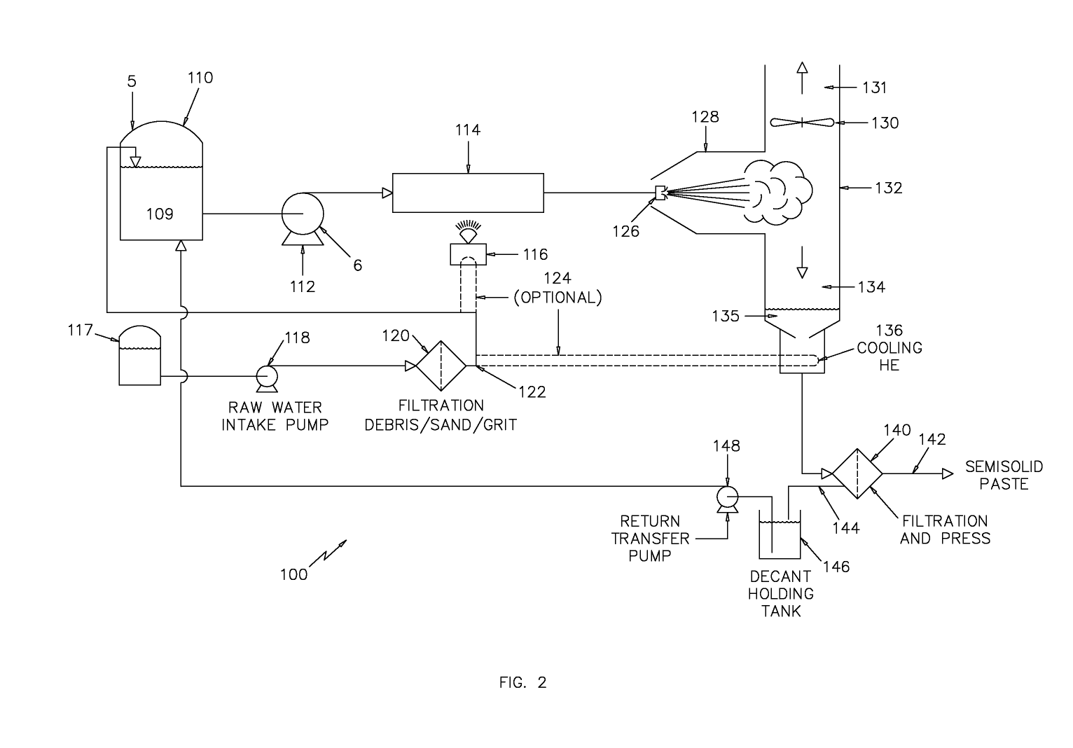

Now referring to FIG. 2, which depicts a device and process 100 for the separation of contaminants from a process fluid in accordance with an embodiment of the invention. A supply of raw water 117 with dissolved contaminates is provided to a first fluid pump 118. The raw water 117 is passed through a filtration unit 120 to remove any debris, sand and/or grit that may be present and then is transferred to a holding tank 110 for further processing. The fluid 109 is provided to a second fluid pump 112 where the temperature and pressure of the fluid 109 is increased (T2, P2).

As discussed previously, the fluid 109 is then transferred to a suitably sized and configured quartz tube 114 and a magnetron 116 is configured to transmit microwave energy to the fluid 109 as it flows through the quartz tube 114. Optionally, a supply of fluid 124 may be provided to cool the magnetron 116 and further raise the temperature of the fluid 109. When the fluid 109 leaves the quartz tube 114, it is at superheated state at temperature T3 and pressure P3.

The superheat fluid is then transferred to a flash vaporization unit 128 which includes a set of atomizing nozzles 126 where the fluid 109 is flash vaporized. Vapor 131 from the flash vaporization is drawn out of the flash vaporization unit 128 by a fan 130 and a super saturated solution 134 which consists of the remaining vapor, condensate and contaminants fall to a collection zone 135 in the vaporization unit 128.

The vapor 131, drawn out by the fan 130, is further cooled and condenses into a supply of uncontaminated fluid or, alternatively, can be vented to atmosphere. It should be noted that the flash vaporization process only has to drop the pressure to a predetermined point so that vapor is released, and not necessarily to atmospheric pressure. It should also be noted that the contaminated process fluid should be preferably at or above atmospheric pressure such that heating the process fluid will result in the contaminated process fluid will exist as a non-boiling superheated state, whereby it is then allowed to flash vaporize across a sudden drop in pressure.

Optional cooling fluid 136, bled from the raw water 117 supply, may be provided to further cool the now heated super saturated solution 134. The super saturated solution 134 is then transferred to a filtration and press unit 140 which is configured to produce a semi solid paste 142 and a decontaminated fluid solution 114. While scaling is not desirable where heat is added to the process, the formation of scale is desirable for removing solids from the solution 134, the formation of scale is encouraged either through flash vaporization by quickly reducing the pressure of the fluid, or by using brine crystallizers that allow scale and crystallization to proceed. Once these scaling products are formed, then they can be filtered, pressed and dried.

The decontaminated fluid solution 144 is transferred to a holding tank 146 for storage. The decontaminated fluid 144 is transferred to a return transfer pump 148 where the fluid 144 is transferred to the holding tank 110 for further processing. The net result is that water is removed and solids are left behind. This is a desirable outcome for inland processes that generate highly saline or high mineral content fluids that are not suitable for traditional disposal.

It should be noted that the device and system 100 is a single stage of what could be a multistage process, where successive system 100 could be connected in series to further process a contaminated fluid.

Although an exemplary embodiment of the invention has been shown and described, many changes, modifications, and substitutions may be made by one having ordinary skill in the art without necessarily departing from the spirit and scope of this invention.

What is claimed is:

1. A device for heating a fluid that results in the elimination or reduction of scale build-up comprising:
a fluid conduit appropriately sized to transfer a fluid at a predetermined flow rate;
an electromagnetic energy source disposed adjacent said fluid conduit, said electromagnetic energy source configured to raise the temperature of the fluid as it flows through said fluid conduit; and,
wherein said fluid conduit is comprised of a material that allows for the transfer of energy into the fluid, but does not itself substantially increase in temperature due to the electromagnetic energy source.

2. The device of claim 1, wherein said electromagnetic energy source is a magnetron.

3. The device of claim 1, wherein said fluid conduit is comprised of quartz.

4. The device of claim 1, further including a fluid pump in fluid communication with said fluid conduit.

5. The device of claim 1, wherein the pressure of the fluid is not substantially changed while flowing through said fluid conduit.

6. A device for the removal of contaminants from a fluid comprising:
a first pump configured to raise the pressure and transfer the fluid to a fluid conduit, wherein said fluid conduit is appropriately sized to transfer the fluid at a predetermined flow rate;
an electromagnetic energy source disposed adjacent said fluid conduit, said electromagnetic energy source configured to raise the temperature of the fluid as it flows through said fluid conduit;
wherein said fluid conduit is comprised of a material that allows for the transfer of energy into the fluid, but does not itself substantially increase in temperature due to the electromagnetic energy source;
a flash vaporization unit configured to create a vapor and super saturated solution from the fluid;
a collection zone configured to receive said super saturated solution; and,
a filtration and press unit configured to receive said super saturated solution and separate said super saturated solution into a semi-solid paste and a decontaminated fluid solution.

7. The device of claim 6, further comprising a fan adjacent said flash vaporization unit, said fan being configured to remove the vapor from said flash vaporization unit.

8. The device of claim 7, wherein said vapor is condensed and retained as a source of uncontaminated fluid.

9. The device of claim 7, wherein said vapor is exhausted to the atmosphere.

10. The device of claim 6, further comprising a supply of brine crystallizers introduced into said flash vaporization unit to support the formation of said semi-solid paste.

11. The device of claim 6, further comprising a supply of cooling fluid in communication with said electromagnetic energy source configured to maintain a predetermined temperature of said electromagnetic energy source.

12. The device of claim 6, wherein said electromagnetic energy source is a magnetron.

13. The device of claim 6, wherein said fluid conduit is comprised of quartz.

14. The device of claim 6, wherein a plurality of devices are connected in series to further process the fluid.

15. A method for raising the temperature of a contaminated process fluid that exhibits the reduction or elimination of scale build-up, comprising the steps of:
transferring a supply of contaminated process fluid to a fluid conduit;
transmitting an electromagnetic wave into said fluid conduit, said electromagnetic wave configured to raise the temperature of the process fluid; and,
wherein said fluid conduit is comprised of a material that allows for the transfer of energy into the process fluid, but does not itself substantially increase in temperature due to the electromagnetic wave.

16. The method of claim 15, wherein said electromagnetic wave is comprised of microwaves.

17. The method of claim 15, wherein said fluid conduit is comprised of quartz.
